(19) United States
(12) Patent Application Publication
(10) Pub. No.: US 2013/0258087 A1
(43) Pub. Date: Oct. 3, 2013

(54) METHOD AND APPARATUS FOR EXECUTING FUNCTION USING IMAGE SENSOR IN MOBILE TERMINAL

(71) Applicant: SAMSUNG ELECTRONICS CO. LTD., Suwon-si (KR)

(72) Inventor: Seonghun JEONG, Seoul (KR)

(73) Assignee: Samsung Electronics Co. Ltd., Suwon-si (KR)

(21) Appl. No.: 13/855,216

(22) Filed: Apr. 2, 2013

(30) Foreign Application Priority Data
Apr. 2, 2012 (KR) 10-2012-0033740

(51) Int. Cl. H04M 1/23

(52) U.S. Cl. CPC H04M 1/23
USPC 348/77

(57) ABSTRACT

A method and an apparatus of executing a function using an image sensor in a mobile terminal are provided. The method includes detecting motion information from data input from an image sensor, determining whether the detected motion information corresponds to stored pattern information, and executing a function corresponding to the stored pattern information when the detected motion information corresponds to the stored pattern information.

### PRIORITY

This application claims the benefit under 35 U.S.C. §119(a) of a Korean patent application filed on Apr. 2, 2012 in the Korean Intellectual Property Office and assigned Serial No. 10-2012-0033740, the entire disclosure of which is hereby incorporated by reference.

### BACKGROUND OF THE INVENTION

1. Field of the Invention

The present invention relates to a method and an apparatus for executing a function in a mobile terminal. More particularly, the present invention relates to a method of executing a function using an image sensor and an apparatus thereof.

2. Description of the Related Art

A mobile terminal has become a necessity for modern people. That is, the mobile terminal is used regardless of age or sex, and has been used as a medium capable of performing a wireless audio call and exchanging information. When it was first introduced, the mobile terminal was recognized as being easy to carry and providing a user the ability to perform a wireless call. With the development of technology, the mobile terminal now provides advanced services and functions. For example, the mobile terminal has developed into a multi-media device capable of performing a phone book function, a morning call function, a music player function, a schedule management function, a digital camera function, a wireless Internet service, and various additional functions and services.

If a wake up event occurs while the mobile terminal operates in a low power mode, that is, a sleep mode, the mobile terminal may transition to and operate in an active mode. As an example, the wake up event may be a key signal input from a key input unit. When the wake up event occurs, the mobile terminal controls a display unit to display a lock release screen.

As discussed above, to convert the mobile terminal from a sleep mode to an active mode, the user needs to perform an operation of directly contacting (e.g., pressing a button) the mobile terminal. However, such an operation is inconvenient to the user in some cases. For example, when both of the user's hands are dirty, the user must wash their hands. Also, if the touch screen is a capacitive type and the user wears gloves on both hands, the user must take off the gloves.

Therefore a need exists for an improved apparatus and method that allows a user to perform various functions included in a mobile terminal without making direct contact with the mobile terminal.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method of executing a function which allows a user to perform various functions included in a mobile terminal without making direct contact with the mobile terminal, and an apparatus thereof.

Another aspect of the present invention is to provide a method of executing a function to execute various functions included in a mobile terminal in response to detection of motion or a specific image using an image sensor, and an apparatus thereof.

Another aspect of the present invention is to provide a method of executing a function capable of driving an image sensor for detecting motion or a specific image at low power, and an apparatus thereof.

In accordance with an aspect of the present invention, a method of executing a function in a mobile terminal is provided. The method includes detecting motion information from data input from an image sensor, determining whether the detected motion information corresponds to stored pattern information, and executing a function corresponding to the stored pattern information when the detected motion information corresponds to the stored pattern information.

In accordance with another aspect of the present invention, a method of executing a function in a mobile terminal is provided. The method includes detecting image information from data input from an image sensor, determining whether the detected image information includes face information, and executing a function corresponding to the face information when the detected image information includes the face information.

In accordance with still another aspect of the present invention, an apparatus for executing a function in a mobile terminal is provided. The apparatus includes an image sensor capable of detecting subject information, a detector capable of detecting motion information from data associated with the subject information input from the image sensor, a memory capable of storing at least one pattern information to be compared with the detected motion information, and a controller capable of executing a function corresponding to the stored pattern information when the detected motion information corresponds to the stored pattern information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal according to an exemplary embodiment of the present invention;

FIGS. 2A to 2D are diagrams illustrating installation of an image sensor in a mobile terminal according to exemplary embodiments of the present invention;

FIGS. 3A to 3G are diagrams illustrating various motion information detected by an image sensor according to exemplary embodiments of the present invention;

FIGS. 4A to 4C are diagrams illustrating a method of driving an image sensor according to an exemplary embodiment of the present invention;

FIG. 5 is a flowchart illustrating a method of executing a function according to a first exemplary embodiment of the present invention;

FIG. 6 is a flowchart illustrating a method of executing a function according to a second exemplary embodiment of the present invention;

FIG. 7 is a flowchart illustrating a method of executing a function according to a third exemplary embodiment of the present invention;

FIG. 8 is a flowchart illustrating a method of executing a function according to a fourth exemplary embodiment of the present invention; and

FIG. 9 is a flowchart illustrating a method of executing a function according to a fifth exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In exemplary embodiments of the present invention, a sleep mode refers to a state in which current consumption of the mobile terminal is minimal or otherwise reduced as compared to other operating modes. The sleep mode may be a state in which a display unit is not driven. In particular, in the sleep mode according to exemplary embodiments of the present invention, an image sensor may drive fewer than all pixels. A pixel refers to one imaging device which converts light energy input from a lens into an electric signal and outputs the converted electric signal by an image sensor. One pixel may include a Red (R) pixel, a Green (G) pixel, and a Blue (B) pixel. The mobile terminal may drive only a part of all pixels of the image sensor in the sleep mode to detect motion or an image. One or more image sensors may be provided. One of a plurality of image sensors may be used for detection or a camera.

In an exemplary embodiment of the present invention, the active mode may be defined as a mode for executing functions included in the mobile terminal in response to external input information (e.g., call, data, touch gesture, key push, etc.). If a wake up event (e.g., key signal, subject information detected by the image sensor (e.g., motion information or specific image information (e.g., face))) is generated, the mobile terminal converts an operation mode of the mobile terminal into an active mode. If the operation mode of the mobile terminal is converted into the active mode, a controller of the mobile terminal drives the display unit. The controller controls the display unit to display image data. In this case, the displayed image data may be a lock screen, a home screen, or an application (hereinafter referred to as ‘App’) execution screen. All pixels of the image sensor may be driven in the active mode.

An exemplary method and apparatus for executing a function according to the present invention are applicable to various types of mobile terminals. That is, an exemplary method and apparatus for executing a function according to the present invention are applicable to a mobile terminal including an image sensor and a touch screen. It is apparent that the mobile terminal may be a portable phone, a smart phone, a tablet Personal Computer (PC), a hand-held PC, a Portable Multimedia Player (PMP), a Personal Digital Assistant (PDA), and the like. For convenience of description, it is assumed that the exemplary method and apparatus for executing a function according to the present invention are applicable to a mobile terminal including an image sensor and a touch screen.

The method and the apparatus for executing a function according to exemplary embodiments of the present invention provide a technology which determines the presence of detection of motion or a specific image, and executes various functions included in a mobile terminal in response to the detection of the motion or the specific image. Since functions executed according to the detection of the motion or the specific image vary, the list of all possible functions is lengthy and therefore not listed for sake of brevity. As an example however, the functions may include mode conversion (i.e., conversion from a sleep mode to an active mode or conversion from the active mode to the sleep mode), lock release, volume control, playback of audio or video, playback pause, call, page turning of electronic (e)-book, photograph turning, and the like. An exemplary method and apparatus for executing a function in a mobile terminal using an image sensor will be described in more detail below.

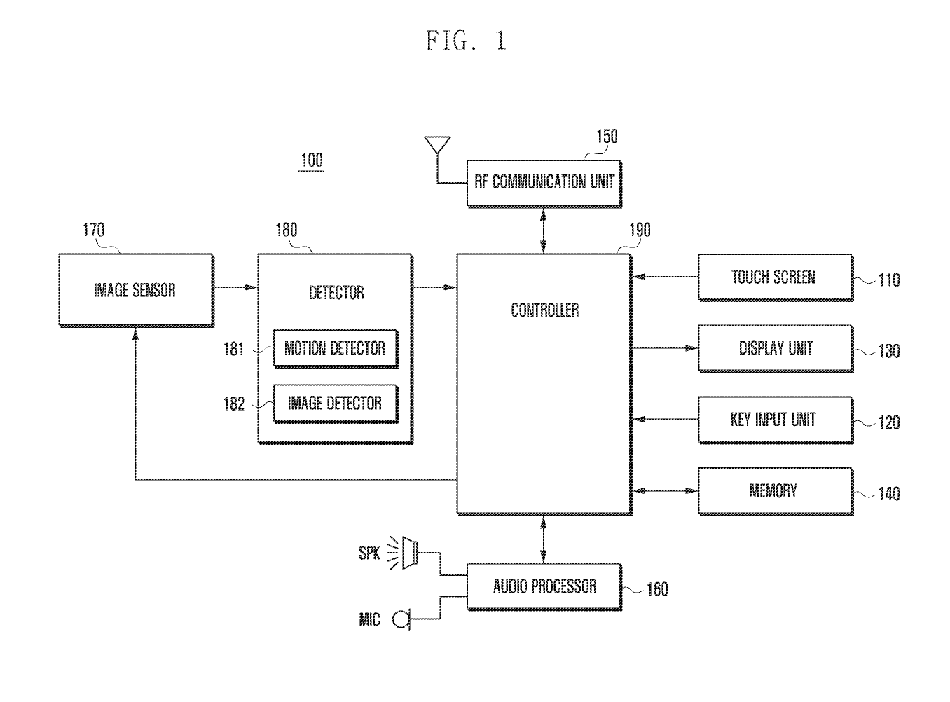

FIG. 1 is a block diagram illustrating a configuration of a mobile terminal according to an exemplary embodiment of the present invention.

Referring to FIG. 1, the mobile terminal 100 may include a touch screen 110, a key input unit 120, a display unit 130, a memory 140, a Radio Frequency (RF) communication unit 150, an audio processor 160, a speaker SPK, a microphone MIC, an image sensor 170, a detector 180, and a controller 190.

The touch screen 110 may be mounted at a front surface of the display unit 130 and generates and transfers a touch event to the controller 190 in response to a touch gesture of the user inputted to the touch screen 110. The controller 190 may detect a user gesture from a touch event inputted from the touch screen 110 and control the constituent elements. The user gesture may be classified into a touch and a touch gesture. Here, the touch gesture may include tap, double tap, long tap, drag, drag & drop, flick, and the like. Here, the touch is an operation where a user pushes one point of a screen using a touch input unit (e.g., finger or stylus pen). The tap is an operation where the user touches-off the touch input unit in a corresponding point without a motion of the touch input unit after touching one point. The double tap is an operation where a user performs a tap operation twice in succession. The long tap is an operation where a finger is released from a corresponding point without a motion of the touch input unit after touching one point longer than the tap. The drag is an operation that moves a finger in a predetermined direction in a state that one point is touched. The drag & drop is an operation that removes a touch input unit after a drag. The flick is an operation that removes a touch input unit after moving it by bouncing at high speed like flipping. The touch means a state contacted on the touch screen, and the touch gesture means a motion from touch-on of the touch on the touch screen to touch-off of the touch. Further, a resistive type, a capacitive type, and a pressure type are applicable to the touch screen 110.

The key input unit 120 may include a plurality of input keys and function keys for receiving numeric or character information and setting various functions. The function keys may include arrow keys, side keys, and hot keys set such that a specific function is performed. The key input unit 120 generates and transfers a key signal associated with user setting and function control of the mobile terminal 100 to the controller 190. The key signal may be classified into an on/off signal, a volume control signal, and a screen on/off signal. The controller 190 controls the foregoing constituent elements in response to the key signal. The key input unit 120 may include a QWERTY keypad, a 3*4 keypad, a 4*3 keypad, and the like, having a plurality of keys. When the touch screen 110 of the mobile terminal 100 is supported in the form of a full touch screen, the key input unit 120 may include only at least one side key for screen on/off and portable terminal on/off, which is provided in a side of a case of the mobile terminal 100.

The display unit 130 converts image data inputted from the controller 190 into an analog signal, and displays the analog signal under the control of the controller 190. That is, the display unit 130 may provide various screens according to use of the portable terminal, for example, a lock screen, a home screen, an App execution screen, a menu screen, a keypad screen, a message creation screen, an Internet screen, and the like. A lock screen may be defined as an image displayed when a screen of the display unit 130 becomes large. When a lock release event (e.g., touch gesture, subject information (e.g., motion information or specific image information (e.g., face)) detected by the image sensor 170) occurs, the controller 190 may convert a displayed image from a lock screen into a home screen, an App execution screen, or another screen as appropriate. The home screen may be defined as an image including a plurality of App icons corresponding to a plurality of Apps, respectively. When an App icon is selected from a plurality of App icons by a user, the controller 190 may execute a corresponding App, for example, electronic book App, and convert a displayed image into an execution screen. The display unit 130 may be configured in the form of a flat panel display such as a Liquid Crystal Display (LCD), an Organic Light Emitted Diode (OLED), an Active Matrix Organic Light Emitted Diode (AMOLED), and the like.

The data area of the memory 140 may store data generated from the mobile terminal 100 according to use of the mobile terminal 100. The data area may store data received through the RF communication unit 150. The data area may store the screen which the display unit 130 displays. The menu screen may include a screen switch key (e.g., a return key for returning to a previous screen) for switching the screen and a control key for controlling a currently executed App. The data area may store data which the user copies from messages, photographs, web pages, or documents for copy & paste. The data area may store various preset values (e.g., screen brightness, presence of vibration during generation of touch, presence of automatic rotation of the screen) for operating the mobile terminal. The data area may store various pattern information to be compared with detected motion information. That is, if there is pattern information corresponding to detected motion information among the stored pattern information, the controller 190 may execute a function according to the corresponding pattern information. The data area may store various pattern information to be compared with the detected image information. If there is information corresponding to the detected image information among the stored pattern information, the controller 190 may execute a function according to the matched pattern information. In the meantime, the stored pattern information may be corrected, modified, or added by the user. The controller 190 may set a function matching with pattern information.

The program area of the memory 140 may store an Operating System (OS) and various Apps for booting the portable terminal and operating the foregoing constituent elements. Since the stored applications vary extensively, all of the applications are not listed for sake of brevity. However, as an example, the stored applications may include a web browser, a Social Network Service (SNS) App, a music player, a video player, and a camera application. More particularly, the program area may include software implementing the method of executing a function according to exemplary embodiments of the present invention. The software may include a configuration included in the foregoing various applications.

The RF communication unit 150 performs voice call, image call, or data communication under the control of the controller 190. To do this, the RF communication unit 150 may include an RF transmitter for up-converting a frequency of a transmitted signal and amplifying the converted signal, and an RF receiver for low-noise-amplifying a frequency of a received signal and down-converting the amplified signal. The RF communication unit 150 may include a mobile communication module (e.g., 3-generation mobile communication module, 3.5-generation mobile communication module, 4-generation mobile communication module, etc.), a Digital Multimedia Broadcasting (DMB) module, and a near field communication module. The near field communication module performs a function of connecting the mobile terminal 100 to an external device in a wired or wireless scheme. The near field communication module may include a Zigbee module, a Wi-Fi module, a Bluetooth module, and the like.

The audio processor 160 transmits an audio signal received from the controller 190 to the speaker, and transfers an audio signal such as a voice received from the microphone to the controller 190. That is, the audio processor 160 converts voice/sound data into a visible sound and outputs the visible sound under the control of the controller 190. The audio processor 160 may convert the audio signal such as the voice received from the microphone into a digital signal and transfers the digital signal to the controller 190. More particularly, the audio processor 160 outputs various sound effects to the speaker under the control of the controller 190. The audio processor 160 may output a sound effect to the speaker as feedback with respect to detection of the motion or the specific image.

The image sensor 170 detects subject information (i.e., light), converts the detected subject information into an electric analog signal, Analog to Digital (AD)-converts the electric analog signal, and outputs the converted digital signal. An exemplary mobile terminal may include one or more image sensors 170. One of the image sensors 170 may be used for a camera. The image sensor 170 (particularly, image sensor for shooting) may drive a part of all pixels under control of the controller 190. For example, the image sensor for shooting may drive a partial pixel for detecting motion and an image of low resolution in a sleep mode and drive all the pixels for detecting an image of high resolution (that is, for the camera) in an active mode.

The image sensor 170 may include a Complementary Metal Oxide Semiconductor (CMOS) image sensor or a Charge Coupled Device (CCD) image sensor.

The detector 180 may include may include a motion detector 181, detecting motion information from data input from the image sensor 170, and an image detector 182, detecting image information from subject information input from the image sensor 170. The detector 180 outputs the detected motion information and the image information to the controller 190. The detector 180 may detect brightness or an amount of change in the brightness from the subject information input from the image sensor 170. The detector 180 may be included in the controller 190. That is, the controller 190 may execute detection functions of motion, an image, and an amount of change in brightness.

The controller 190 performs a function of controlling an overall operation of the portable terminal 100, signal flow between internal constituent elements of the portable terminal 100, and processing of data. The controller 190 controls power supplied from a battery to internal constituent elements. The controller 190 may execute various applications stored in a program area. The controller 190 may perform a method of executing various functions according to exemplary embodiments of the present invention.

Since the structural elements can be variously changed according to the convergence trend of a digital device, an exhaustive list of all possible elements is not included for sake of brevity. However, as an example, the mobile device 100 may further include constituent elements having additional functions such as an MP3 module and a camera module. In the exemplary mobile terminal 100 of the present invention, specific constituent elements may be omitted from the foregoing constituent elements or replaced by other constituent elements according to the provision form. The exemplary input unit of the present invention may include a touch pad, a track ball, and a key board as well as the touch screen 110 and the key input unit 120.

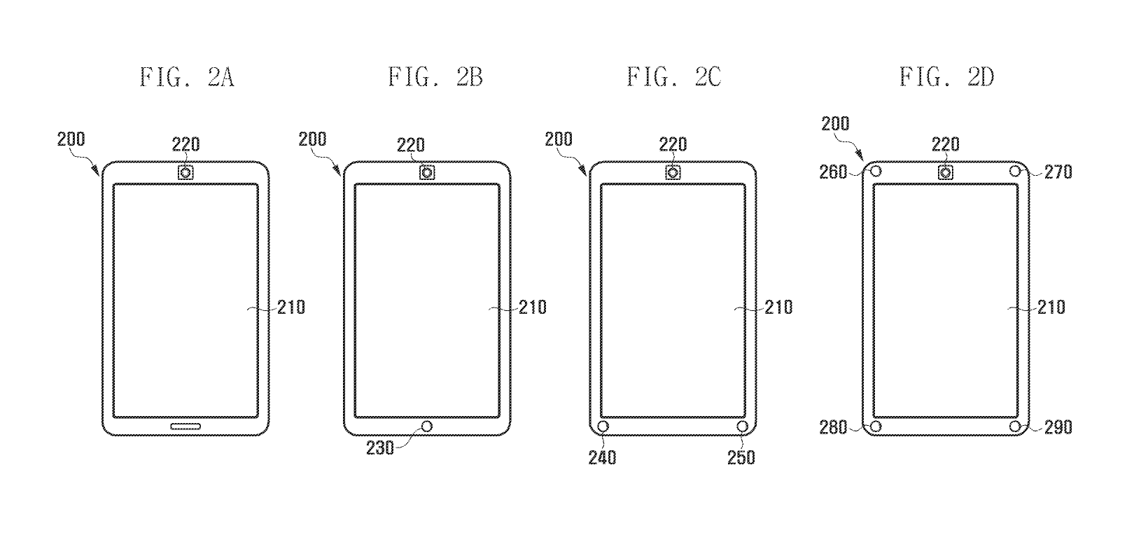

FIGS. 2A to 2D are diagrams illustrating installation of an image sensor in a mobile terminal according to exemplary embodiments of the present invention.

Referring to FIGS. 2A to 2D, the first image sensor 220 is installed at a front surface 200 of the mobile terminal 100. More particularly, as shown in FIGS. 2A to 2D, the first image sensor 220 may be installed around a screen 210. Of course, the present invention is not limited to the number of image sensors or the installation locations of the image sensor as described in the figures.

In more detail, the first image sensor 220 may be installed at the center of a top end of the screen 210 as illustrated in FIG. 2A. A lens and a protective layer (e.g., glass or transparent film) may be laminated at an upper portion of the first image sensor 220. The first image sensor 220 may be used for detecting motion, an image of low resolution, and an image for high resolution. The first image sensor 220 may drive a part of all pixels under the control of the controller 190.

Referring to FIG. 2B, the first image sensor 220 and a second image sensor 230 may be installed at the centers of top and bottom ends of the screen 210, respectively. In FIG. 2B, the first image sensor 220 may be used for detecting motion, an image of low resolution, and an image for high resolution. The second image sensor 230 may be used to detect the motion. The controller 190 may determine that motion information is detected only when motion information detected by the second image sensor 230 corresponds to motion information detected by the first image sensor 220.

Referring to FIG. 2C, the first image sensor 220 may be installed at the center of a top end of the screen 210, a third image sensor 240 may be installed at a left side of a bottom end of the screen 210, and a fourth image sensor 250 may be installed at a right side of the bottom end of the screen 210. In FIG. 2C, the first image sensor 220 may be used for detecting an image of low resolution and an image for high resolution. The third image sensor 240 and the fourth image sensor 250 may be used to detect the motion. The controller 190 may determine that the motion information is detected only when motion information detected by the fourth image sensor 250 corresponds to motion information detected by the third image sensor 240.

Referring to FIG. 2D, the first image sensor 220 may be installed at the center of a top end of the screen 210, a fifth image sensor 260 may be installed at a left side of the top end of the screen 210, a sixth image sensor 270 may be installed at a right side of the top end of the screen 210, a seventh image sensor 280 may be installed at a left side of a the bottom end of the screen 210, and an eighth image sensor 290 may be installed at a right side of the bottom end of the screen 210.

Referring to FIG. 2D, the first image sensor 220 may be used for detecting an image of low resolution and an image for high resolution. The fifth image sensor 260, the sixth image sensor 270, the seventh image sensor 280, and the eighth image sensor 290 may be used to detect the motion. The controller 190 may determine that the motion information is detected only when motion information detected by the fourth image sensor 250 corresponds to motion information detected by the third image sensor 240. More particularly, the controller 190 may determine that the motion information is detected only when directions of detected motion information correspond to each other. For example, if the directions of detected motion information correspond to each other clockwise or counterclockwise, the controller 190 may determine that the motion information is detected.

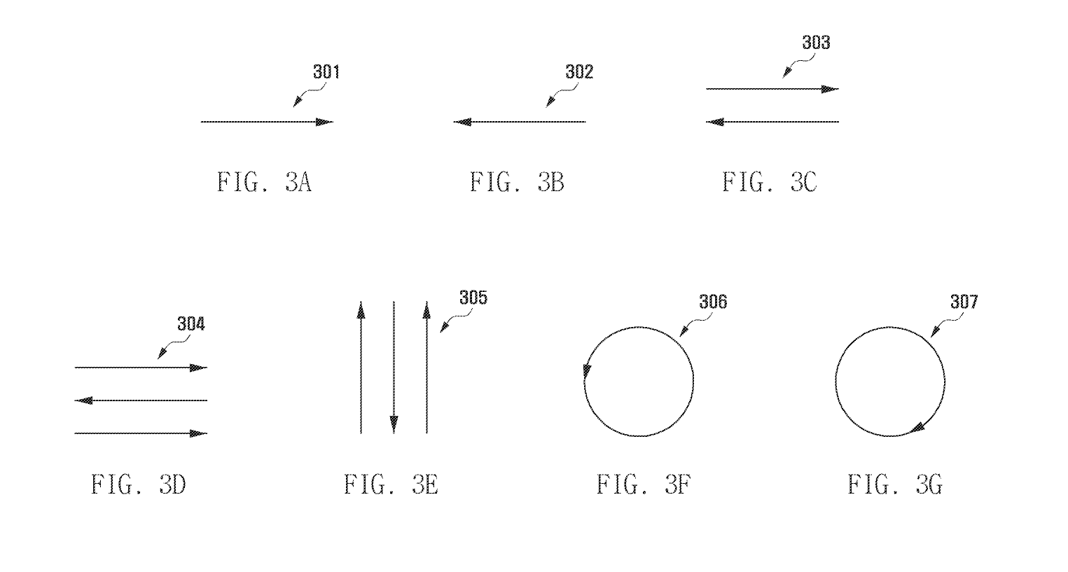

FIGS. 3A to 3G are diagrams illustrating various motion information detected by an image sensor according to exemplary embodiments of the present invention.

Referring to FIG. 3A, the user may move a predetermined subject (e.g., hand or pen) from a left side to a right side (→) on a front surface of the mobile terminal. The user does not contact the subject on the front surface 200 of the mobile terminal but simply moves the subject in the air. Then, one or more image sensors may detect motion of the subject and transfer corresponding information to the detector 180. The detector 180 may individually detect first motion information 301 from subject information from the one or more image sensors.

FIGS. 3B to 3G, which are substantially the same as FIG. 3A, will not be explained in detail to avoid repetition. Referring to FIG. 3B, the user may move the subject from the right side to the left side (←) on the front surface 200 of the mobile terminal. The detector 180 may detect second motion information 302. Referring to FIG. 3C, the user may move the subject from the left side to the right side (→) and then from the right side to the left side (←). Accordingly, the detector 180 may detect third motion information 303. Referring to FIG. 3D, the user may move the subject in an order of “→, ←, →”. Then, the detector 180 may detect fourth motion information 304. Referring to FIG. 3E, the user may move the subject from down to up (↑), from up to down (↓), and from down to up (↑). Accordingly, the detector 180 may detect fifth motion information 305. Referring to FIG. 3F, the user may rotate the subject counterclockwise. Accordingly, the detector 180 may detect sixth motion information 306. Referring to FIG. 3G, the user may rotate the subject clockwise. Accordingly, the detector 180 may detect seventh motion information 307.

Referring back to FIG. 2B, the detector 180 may detect motion information, for example, first motion information through one of a first image sensor 220 and a second image sensor 230, and detect motion information other than the first motion information through a remaining image sensor or cannot detect the motion information. That is, the user may move the subject at only a top end of a screen in which the first image sensor 220 is located. The user may move the subject at only a bottom end of the screen in which the second image sensor 230 is located. The controller 190 may determine that the motion information is detected only when motion information is detected through the first image sensor 220 and the second image sensor 230, and motion information detected through the second image sensor 230 corresponds to the motion information detected through the first image sensor 220. That is, when the motion information detected through the second image sensor 230 corresponds to the motion information detected through the first image sensor 220, the controller 190 may execute a function corresponding to the detected motion information. Although the motion information is detected through only one of the first image sensor 220 and the second image sensor 230, the controller 190 may determine that the motion information is detected.

Referring back to FIG. 2C, the detector 180 may detect motion information, for example, fifth motion information through one of a third image sensor 240 and a fourth image sensor 250, and detect motion information other than the fifth motion information through a remaining one image sensor or may not detect the motion information. That is, the user may move the subject at only a left side of a screen in which the third image sensor 240 is located. The user may move the subject at only a right side of the screen in which the fourth image sensor 250 is located. The controller 190 may determine that the motion information is detected only when motion information is detected through the third image sensor 240 and the fourth image sensor 250, and motion information detected through the fourth image sensor 250 corresponds to the motion information detected through the third image sensor 240. Although the motion information is detected through only one of the third image sensor 240 and the fourth image sensor 250, the controller 190 may determine that the motion information is detected.

Referring back to FIG. 2D, the detector 180 detects motion information through a fifth image sensor 260, a sixth image sensor 270, a seventh image sensor 280, and an eighth image sensor 290, and transfers the detected motion information to the controller 190. If direction information (e.g., clockwise) of the detected motion information corresponds to each other, the controller 190 may determine that the motion information is detected.

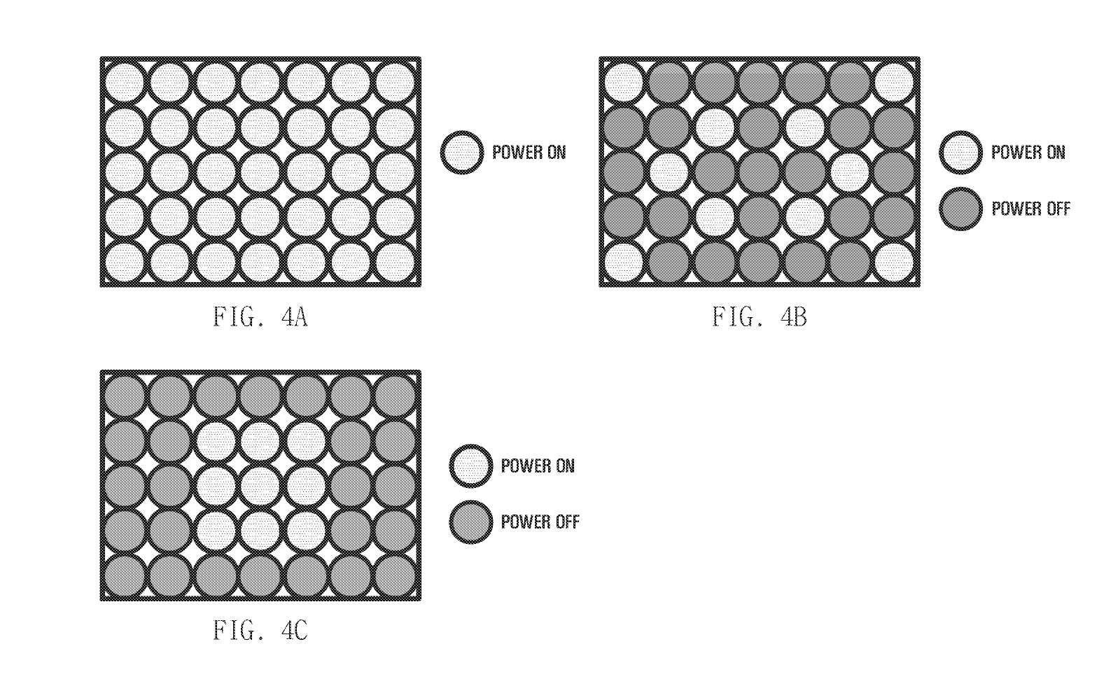

FIGS. 4A to 4C are diagrams illustrating a method of driving an image sensor according to an exemplary embodiment of the present invention.

Referring to FIG. 4A, power to all pixels of the image sensor may be turned-on under the control of the controller 190. Accordingly, all the pixels of the image sensor may detect subject information. The controller 190 may drive all the pixels of the image sensor in an active mode.

Referring to FIG. 4B, the controller 190 may drive the image sensor to detect motion. However, the controller 190 may drive fewer than all of the pixels to reduce current consumption. More particularly, the controller 190 may drive fewer than all of the pixels when in a sleep mode.

Referring to FIG. 4C, the controller 190 may drive the image sensor to detect an image. However, when an image of high resolution is not required, the controller 190 may drive fewer than all of the pixels to reduce current consumption. More particularly, the controller 190 may drive fewer than all of the pixels in the sleep mode. In this case, the driven pixels are used to detect the image, and peripheral pixels are unnecessary to be turned-on as shown in FIG. 4C.

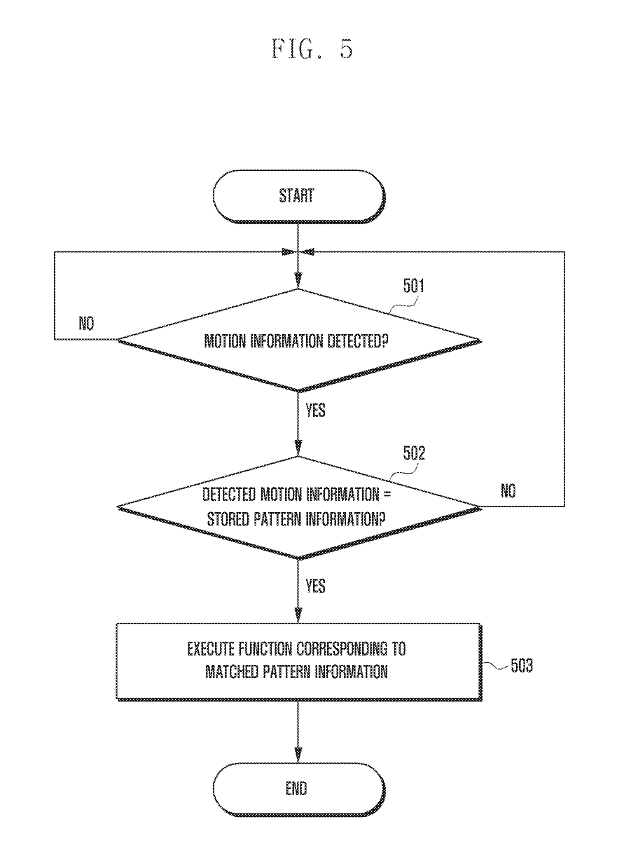

Since methods of executing a function according to exemplary embodiments of the present invention vary extensively, all the methods are not listed for sake of brevity. However, several exemplary embodiments will be described with reference to FIGS. 5 to 9.

FIG. 5 is a flowchart illustrating a method of executing a function according to a first exemplary embodiment of the present invention.

Referring to FIG. 5, the controller 190 may operate the mobile terminal in an active mode or a sleep mode. The controller 190 may drive all or fewer than all of the pixels of the image sensor 170. The controller 190 determines whether motion information is detected in step 501. If the motion information is detected, the controller 190 determines whether the detected motion information corresponds to stored pattern information in step 502. Information concerning one or more patterns may be provided. If the detected motion information corresponds to stored pattern information, the controller 190 may execute a function corresponding to matched pattern information in step 503. Since the number and type of executed functions vary extensively, all possible functions are not listed for sake of brevity. As an example however, the functions may include operation mode conversion, lock release, volume control, playback of audio or video, playback pause, call, page turning of electronic (e)-book, photograph turning, and the like.

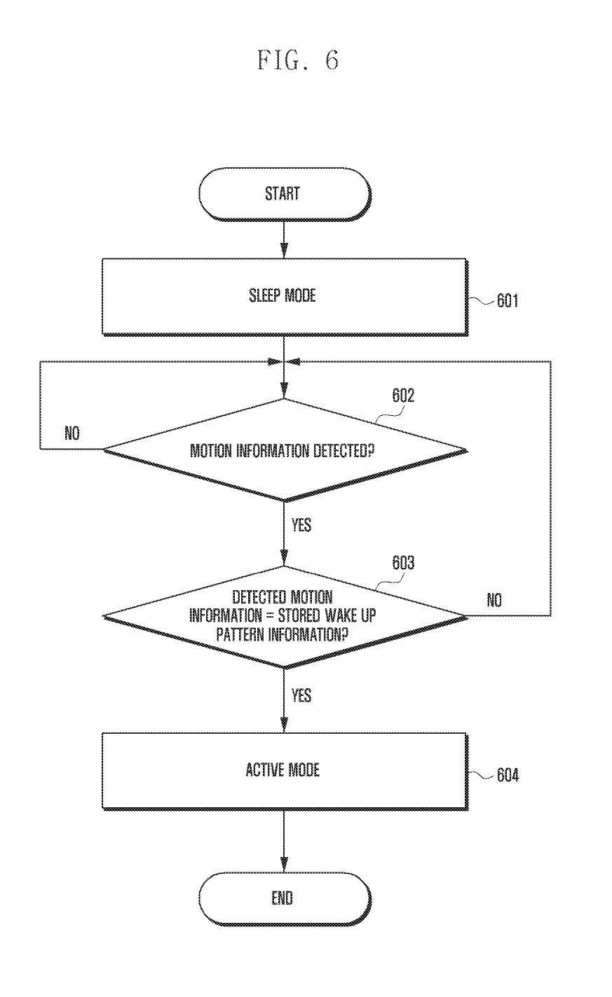

FIG. 6 is a flowchart illustrating a method of executing a function according to a second exemplary embodiment of the present invention.

Referring to FIG. 6, the controller 190 may operate the mobile terminal 100 in a sleep mode in step 601. More particularly, the controller 190 may drive fewer than all pixels of an image sensor 170. The controller 190 determines whether motion information is detected in step 602. If the motion information is detected, the controller 190 determines whether the detected motion information corresponds to stored wake up pattern information (e.g., sixth motion information 306) in step 603. If the detected motion information corresponds to stored wake up pattern information, the controller 190 may operate the mobile terminal 100 in an active mode in step 604. For example, the controller 190 may control a display unit 130 to display a home screen, an App execution screen (e.g., preview screen of a camera) of the latest executed application, and the like in step 604.

Meanwhile, if sleep pattern information (e.g., seventh motion information 307) is detected while the mobile terminal 100 operates in an active mode, the controller 190 may convert an operation mode from the active mode to a sleep mode. However, although the operation mode is changed to the sleep mode, functions (e.g., data download, music playback, push alarm) executed in a background may be continuously executed. The push refers to an operation of periodically transmitting a keep alive packet to a server to maintain connection with the server. That is, the push alarm refers to a function that reports a message received from the server to the user according to the push. An application executing the push and the push alarm varies and may include an SNS service application, an e-mail application, and the like, and is generally known in the art, thus a description thereof is omitted.

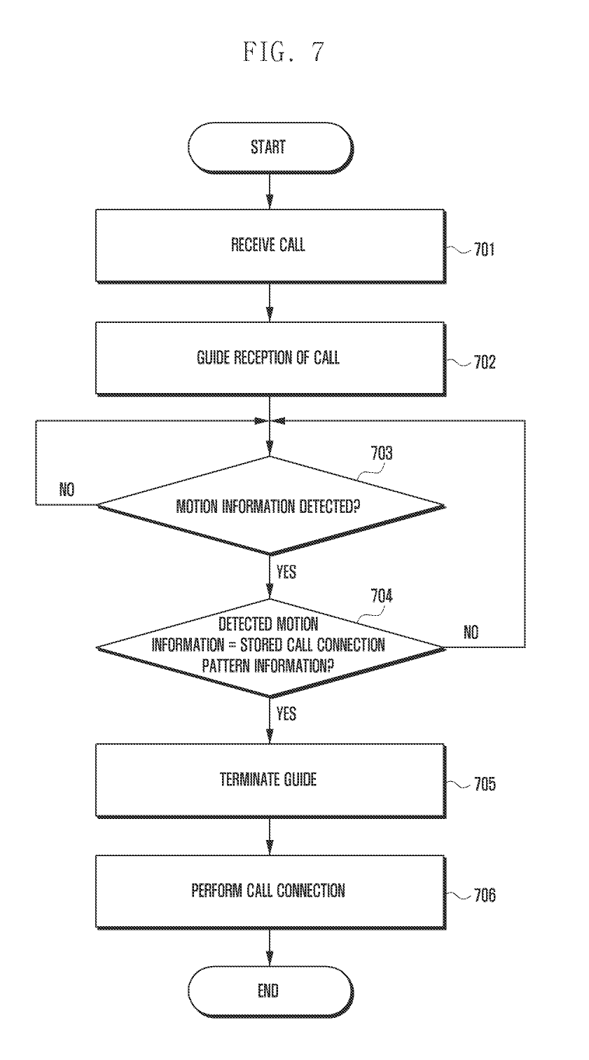

FIG. 7 is a flowchart illustrating a method of executing a function according to a third exemplary embodiment of the present invention.

Referring to FIG. 7, when a mobile terminal 100 is in a sleep mode or an active mode, an RF communication unit 150 may receive a call from a base station in step 701. Accordingly, the controller 190 may guide reception of the call to the user in step 702. A guide scheme may use voice, vibration, a call reception screen, and the like. While guiding the reception of the call, the controller 190 determines whether motion information is detected in step 703. If the motion information is detected, the controller 190 determines whether the detected motion information corresponds to stored call connection pattern information (e.g., first motion information 301) in step 704. If the detected motion information corresponds to stored call connection pattern information, the controller 190 terminates the guide in step 705 and performs call connection in step 706. That is, the controller 190 outputs voice data received from the RF communication unit 150 to the audio processor 160, and transfers voice data received from the audio processor 160 to the RF communication unit 150 in step 706.

Meanwhile, during the guiding of the reception of the call, the controller 190 may compare detected brightness with a preset threshold. As a comparison result, when the detected brightness is less than the preset threshold, the controller 190 terminates the guide and performs call connection. For example, it may be assumed that the user moves a smart phone near to an ear for voice call. When the user moves the smart phone near to the ear, the detected brightness may be reduced to the threshold or less. Accordingly, the controller 190 may terminate the guiding of the call reception and perform the call. That is, the user may receive the call without operating a touch screen 110 or a key input unit 120.

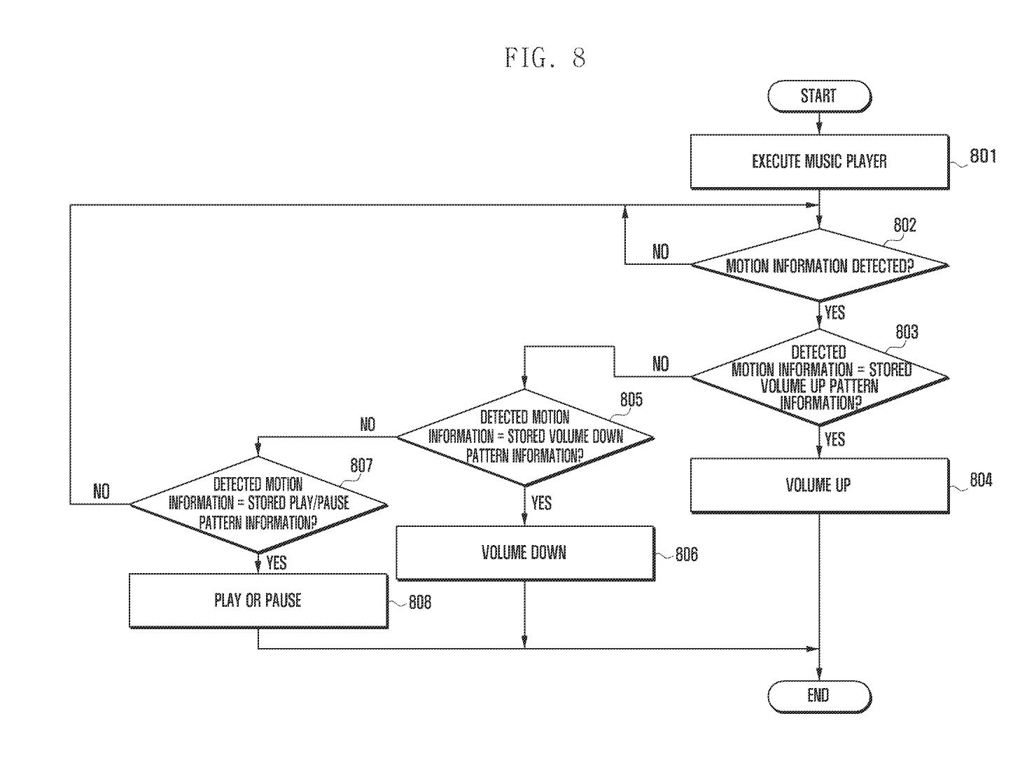

FIG. 8 is a flowchart illustrating a method of executing a function according to a fourth exemplary embodiment of the present invention.

Referring to FIG. 8, a controller 190 may execute various applications in step 801. For example, the controller 190 may execute a music player in step 801. Accordingly, the display unit 130 may display an execution screen of the music player. While the music player is executed, the controller 190 determines whether motion information is detected in step 802. If the motion information is detected, the controller 190 determines whether the detected motion information corresponds to stored volume up pattern information (e.g., moving subject from down to up (↑)) in step (803. If the detected motion information corresponds to the stored volume up pattern information, the controller 190 increases a volume by one level in step 804. For example, if the detected motion information is fifth motion information 305, the controller 190 increases the volume by two levels. If the detected motion information does not correspond to the stored volume up pattern information, the controller 190 determines whether the detected motion information corresponds to stored volume down pattern information (e.g., moving the subject from up to down (↓)) in step 805. If the detected motion information corresponds to the stored volume down pattern information, the controller 190 reduces the volume by one level in step 806.

If the detected motion information does not correspond to the stored volume down pattern information, the controller 190 determines whether the detected motion information corresponds to stored play/pause pattern information (e.g., third motion information 303) in step 807. If the detected motion information corresponds to the stored play/pause pattern information, the controller 190 performs the play or the pause in step 808. That is, if the application is playing, the controller 190 performs the pause. If the application pauses, the controller 190 performs the play.

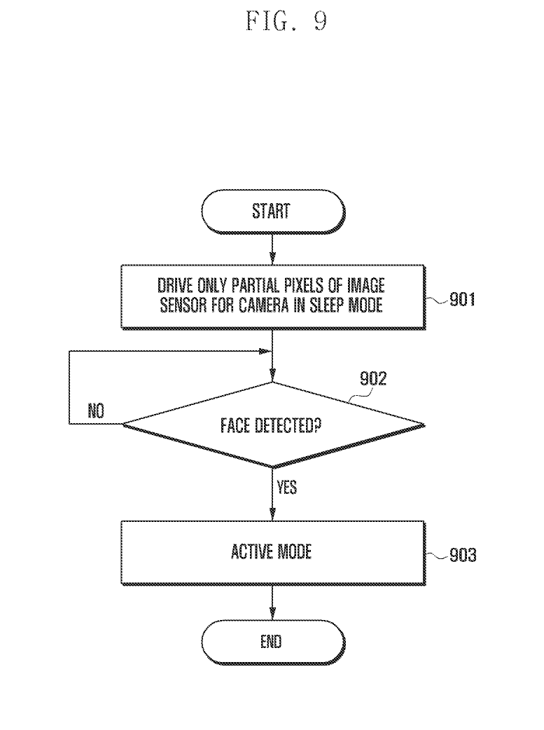

FIG. 9 is a flowchart illustrating a method of executing a function according to a fifth exemplary embodiment of the present invention.

Referring to FIG. 9, a controller 190 may operate a mobile terminal in a sleep mode in step 901. In the sleep mode, the controller 190 may drive fewer than all of the pixels of an image sensor for a camera in step 901. The controller 190 determines whether a specific image, for example, face information is detected in step 902. A technology of determining whether the face information is detected is generally known in a graphics processing field, and thus a detailed description thereof is omitted. If the face information is detected, the controller 190 may operate the mobile terminal 100 in the active mode in step 903. For example, it may be assumed that the user locates a smart phone in a sleep mode at a front side of a face of the user. According to the fifth exemplary embodiment, the user may turn-on the screen without operating the touch screen 110 or the key input unit 120.

The foregoing exemplary methods for executing a function of the present invention may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM, Random Access Memory (RAM), flash memory storing and executing program commands. Further, the program command includes a machine language code created by a complier and a high-level language code executable by a computer using an interpreter. The foregoing hardware device may be configured to be operated as at least one software module to perform an operation of the present invention

As mentioned above, according to exemplary methods of executing a function in a mobile terminal and an apparatus thereof, the present invention allows the user to execute various functions included in the mobile terminal without directly contacting the mobile terminal. More particularly, the present invention may provide a method of executing various functions included in the mobile terminal in response to detection of motion or a specific image using an image sensor and an apparatus thereof. In addition, exemplary embodiments of the present invention may drive fewer than all pixels of an image sensor to reduce current consumption.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of executing a function in a mobile terminal, the method comprising:
detecting motion information from data input from an image sensor;
determining whether the detected motion information corresponds to stored pattern information; and
executing a function corresponding to the stored pattern information when the detected motion information corresponds to the stored pattern information.

2. The method of claim 1, wherein the detecting of the motion information is performed while a display unit is not driven.

3. The method of claim 2, wherein the detecting of the motion information comprises:
driving fewer than all pixels of the image sensor; and
detecting the motion information from the data input from the image sensor in which the fewer than all pixels are driven.

4. The method of claim 3, wherein the determining of whether the detected motion information corresponds to stored pattern information comprises determining whether the detected motion information corresponds to stored wake up pattern information.

5. The method of claim 4, wherein the executing of the function comprises driving the display unit when the detected motion information corresponds to the wake up pattern information.

6. The method of claim 1, wherein the detecting of the motion information comprises detecting respective motion information from data input from a plurality of image sensors, and
the executing of the function is performed when all of the detected motion information corresponds to the stored pattern information.

7. The method of claim 1, wherein the detecting of the motion information comprises detecting at least one of a left motion, a right motion, an up motion, a down motion, and a circular motion.

8. A method of executing a function in a mobile terminal, the method comprising:
detecting image information from data input from an image sensor;
determining whether the detected image information includes face information; and
executing a function corresponding to the face information when the detected image information includes the face information.

9. The method of claim 8, wherein the detecting of the image information is performed while a display unit is not driven.

10. The method of claim 9, wherein the detecting of the image information comprises:
driving fewer than all pixels of the image sensor; and
detecting the image information from the data input from the image sensor in which the fewer than all pixels are driven.

11. The method of claim 10, wherein the executing of the function comprises driving the display unit when the detected image information corresponds to the face information.

12. An apparatus for executing a function in a mobile terminal, the apparatus comprising:
an image sensor capable of detecting subject information;
a detector capable of detecting motion information from data associated with the subject information input from the image sensor;
a memory capable of storing at least one pattern information to be compared with the detected motion information; and
a controller capable of executing a function corresponding to the stored pattern information when the detected motion information corresponds to the stored pattern information.

13. The apparatus of claim 12, wherein the controller controls a display unit to display image data when the detected information corresponds to the stored pattern information.

14. The apparatus of claim 12, wherein the controller drives fewer than all pixels of the image sensor.

15. The apparatus of claim 12, wherein the detector detects respective motion information from data input from a plurality of image sensors, and
the controller executes the function corresponding to the stored pattern information when all of the detected motion information corresponds to the stored pattern information.

16. The apparatus of claim 12, wherein the detector detects image information from data input from the image sensor, and
the controller executes a function corresponding to face information when the detected image information is the face information.

17. The apparatus of claim 16, wherein the controller controls the display unit to display image data when the detected image information is the face information.

18. The apparatus of claim 12, wherein the detector detects the motion information by detecting at least one of a left motion, a right motion, an up motion, a down motion, and a circular motion.
